(19) United States
(12) Patent Application Publication
(10) Pub. No.: US 2019/0054870 A1
(43) Pub. Date: Feb. 21, 2019

(54) IN-VEHICLE POWER SUPPLY DEVICE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Yoshihiro Hida, Yokkaichi, Mie (JP)

(73) Assignees: AutoNetworks Technologies, Ltd., Yokkaichi, Mie (JP); SUMITOMO ELECTRIC INDUSTRIES, LTD., Osaka-shi, Osaka (JP); Sumitomo Wiring Systems, Ltd., Yokkaichi, Mie (JP); SUMITOMO ELECTRIC INDUSTRIES, LTD., Osaka-shi, Osaka (JP)

(21) Appl. No.: 15/761,451

(22) PCT Filed: Sep. 12, 2016
(86) PCT No.: PCT/JP2016/076805

§ 371 Date: Mar. 20, 2018

(30) Foreign Application Priority Data
Sep. 24, 2015 (JP) 2015-186487

(51) Int. Cl. B60R 16/033; H02J 7/14

(52) U.S. Cl. CPC B60R 16/033; H02J 7/1423

(57) ABSTRACT

Provided is an in-vehicle power supply device that is less susceptible to the occurrence of sneak current between a main battery and a sub-battery that supply power externally. The in-vehicle power supply device includes a main battery for in-vehicle use, a sub-battery for in-vehicle use, a switch, a main power supply path, a sub-power supply path, a relay, and wiring. The switch has a first end connected to the main battery and the main power supply path, and a second end connected to the sub-battery. The relay has a first contact connected to a sub-power supply path, and a second contact connected to the second end. The first contact and the second contact form a pair. The wiring is a connection path that connects the first end and the first contact, and supplies power from the main battery to the sub-power supply path.

### CROSS-REFERENCE TO RELATED APPLICATIONS

This application is the U.S. national stage of PCT/JP2016/076805 filed Sep. 12, 2016 which claims priority of Japanese Application No. JP 2015-186487 filed Sep. 24, 2015.

### TECHNICAL FIELD

This disclosure relates to an in-vehicle power supply device.

### BACKGROUND

In recent years, advances have been made in the electrification of vehicle loads. There are also electrified loads that perform functions relating to travelling, steering and stopping. Therefore, loss of the battery function (including malfunction thereof; this similarly applies below) should be avoided. In view of this, a technology for mounting a sub-battery as a backup supply device has been proposed (refer to JP 2015-83404A below).

In JP 2015-83404A, power is supplied to an in-vehicle load (hereinafter, “backup load”) that is for backing up from a main battery and a sub-battery.

In JP 2015-83404A, as long as the main battery has not deteriorated and the charging rate of the sub-battery is within a suitable range, the main battery and the sub-battery are connected in parallel to the backup load via a switch. This causes concern about the occurrence of sneak current between the main battery and the sub-battery.

In view of this, an object of the present invention is to provide an in-vehicle power supply device that is less susceptible to the occurrence of sneak current between a main battery and a sub-battery that supply power externally.

### SUMMARY

An in-vehicle power supply device includes a main battery for in-vehicle use, a sub-battery for in-vehicle use, a switch, a main power supply path, a relay, and a connection path. The switch has a first end connected to the main battery, and a second end connected to the sub-battery. The main power supply path connects the main battery and the first end. The relay has a first contact connected to an in-vehicle load, and a second contact connected to the second end. The first contact and the second contact form a pair. The connection path connects the first end and the first contact, and supplies power from the main battery to the in-vehicle load.

An in-vehicle power supply device that is less susceptible to the occurrence of sneak current between a main battery and a sub-battery that supply power externally is provided.

### BRIEF DESCRIPTION OF DRAWINGS

FIG. 1 is a diagram showing an in-vehicle power supply device according to a first embodiment.

FIG. 2 is a diagram showing an in-vehicle power supply device according to a second embodiment.

FIG. 3 is a circuit diagram showing a first comparative example.

FIG. 4 is a circuit diagram showing a second comparative example.

### DETAILED DESCRIPTION OF PREFERRED EMBODIMENTS

### Comparative Example

In order to clarify the advantages of embodiments that will be discussed later, firstly comparative examples will be described as technologies for comparison with the embodiments.

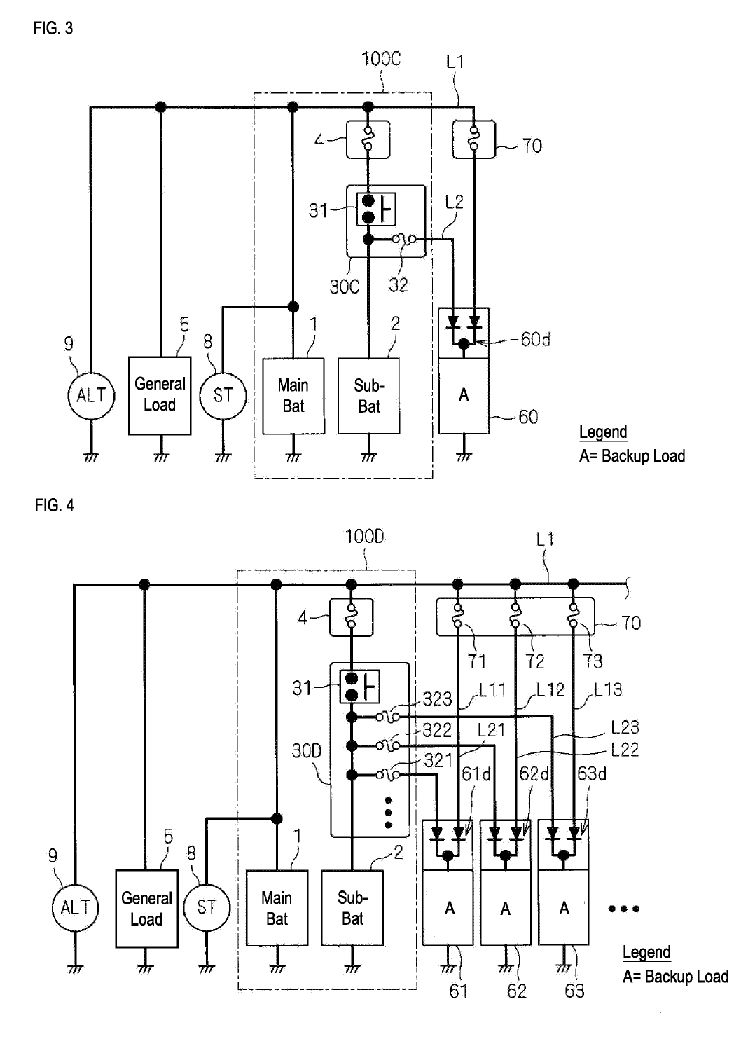

FIG. 3 is a circuit diagram showing a first comparative example. An in-vehicle power supply device 100C is provided with a main battery 1, a sub-battery 2, and a power supply box 30C.

The main battery 1 is for in-vehicle use and is charged from outside the in-vehicle power supply device 100C. Specifically, the main battery 1 is connected to an alternator 9 that is mounted in the vehicle, and is charged by a power generation function of the alternator 9.

A starter 8 together with a general load 5 is connected to the main battery 1, from outside the in-vehicle power supply device 100C. The general load 5 is a load that is not for backing up by the sub-battery 2, and is an in-vehicle air conditioner, for example. The starter 8 is a motor for starting an engine which is not shown. Because the general load 5 and the starter 8 are well-known loads and do not have characteristic features in the comparative examples or the embodiments, a detailed description thereof will be omitted.

A backup load 60 is a load to which power supply is desirably maintained even when power supply from the main battery 1 is lost, and a shift-by-wire actuator and an electronic brake force distribution system can be given as examples.

The sub-battery 2 is for in-vehicle use and is charged by at least one of the alternator 9 and the main battery 1. A lead storage battery, for example, is employed for the main battery 1, and a lithium ion battery, for example, is employed for the sub-battery 2. The main battery 1 and the sub-battery 2 are both concepts that include a capacitor, and an electric double-layer capacitor, for example, can also be employed for the sub-battery 2.

So that the charging current to the sub-battery 2 does not become over-current, the in-vehicle power supply device 100C is further provided with a fuse that interposes the power supply box 30C (specifically, a switch 31 discussed later) together with the sub-battery 2 and is connected in series to both thereof. The fuse is housed in a fuse box 4 in the illustrative example of FIG. 3.

The in-vehicle power supply device 100C supplies power to the backup load 60, via a main power supply path L1 and a sub-power supply path L2. The main power supply path L1 connects the main battery 1, the general load 5 and the backup load 60 in parallel, between the main power supply path and a fixed potential point (here, ground). That is, the general load 5 and the backup load 60 both receive power via the main power supply path L1.

The sub-power supply path L2 is connected to the power supply box 30C, and serves as a path for supplying power from the sub-battery 2 to the backup load 60. Accordingly, the backup load 60 is capable of receiving power not only from the main battery 1 via the main power supply path L1 but also from the sub-battery 2 via the sub-power supply path L2.

In order to prevent over-current in power supply to the backup load 60, a fuse is provided on both the main power supply path L1 and the sub-power supply path L2. FIG. 3 illustrates the case where the fuse on the main power supply path L1 is provided in a fuse box 70, and a fuse 32 on the sub-power supply path L2 is provided in the power supply box 30C.

The power supply box 30C houses the switch 31 and the abovementioned fuse 32. A relay, for example, can be employed for the switch 31. The sub-power supply path L2 is lead out from a connection point of the sub-battery 2 and the switch 31.

When charging the sub-battery 2, the switch 31 is in a closed state, and when not charging the sub-battery 2, the closed state/open state is selected according to the operation. In the comparative examples and the embodiments, such selection of the closed state/open state of the switch 31 when not charging the sub-battery 2 is not essential. Therefore, a detailed description of this selection will be omitted, suffice to pointing out that, here, the selection is performed by a control device which is not shown, such as an in-vehicle ECU (engine control unit), for example.

Incidentally, although not clear from JP 2015-83404A, it is desirable to avoid sneak current between the main battery 1 and the sub-battery 2 (hereinafter, provisionally “inter-battery circulating current”), in the case of supplying power to the backup load 60 with two power supply paths in this way. This is because inter-battery circulating current causes degradation of one or both of the main battery 1 and the sub-battery 2.

The occurrence of inter-battery circulating current can be avoided with a diode group 60d that is provided accompanying the backup load 60. Here, the case where both the main battery 1 and the sub-battery 2 supply power to the backup load 60 at a higher potential than ground is envisaged. Both cathodes of a pair of diodes constituting the diode group 60d are disposed facing the backup load 60, and anodes thereof are respectively disposed facing the main power supply path L1 and the sub-power supply path L2.

FIG. 4 is a circuit diagram showing a second comparative example. An in-vehicle power supply device 100D is provided with a main battery 1, a sub-battery 2 and a power supply box 30D. In the second comparative example, a plurality of backup loads 61, 62, 63 and so on are provided, different from the first comparative example.

In the second comparative example, a main power supply path L1 connects the main battery 1, a general load 5 and the backup loads 61, 62, 63 and so on in parallel between the main power supply path and ground, similarly to the first comparative example. The general load 5 receives power via a main power supply path L1, similarly to the first comparative example.

The main power supply path L1 branches into power supply branches L11, L12, L13 and so on, and the branches respectively serve as power supply paths to the backup loads 61, 62, 63 and so on. In order to prevent over-current in the backup loads 61, 62, 63 and so on, fuses 71, 72, 73 and so on respectively corresponding to the power supply branches L11, L12, L13 and so on are provided. FIG. 4 illustrates the case where the fuses 71, 72, 73 and so on are housed in a fuse box 70.

The in-vehicle power supply device 100D in the second comparative example has a configuration in which the power supply box 30C of the in-vehicle power supply device 100C in the first comparative example is replaced by the power supply box 30D. The power supply box 30D has the switch 31 described in the first comparative example. The switch 31 is interposed between the sub-battery 2 and the fuse that is in the fuse box 4, and is connected in series to both thereof.

In the second comparative example, a plurality of sub-power supply paths L21, L22, L23 and so on are provided instead of the sub-power supply path L2 shown in the first comparative example, and these sub-power supply paths are lead out from the power supply box 30D, or more specifically, from connection points of the sub-battery 2 and the switch 31. The sub-battery 2 respectively supplies power to the backup loads 61, 62, 63 and so on, via the sub-power supply paths L21, L22, L23 and so on. In order to prevent over-current in the backup loads 61, 62, 63 and so on, fuses 321, 322, 323 and so on respectively corresponding to the sub-power supply paths L21, L22, L23 and so on are provided. FIG. 4 illustrates the case where the fuses 321, 322, 323 and so on are housed in the power supply box 30D.

The backup load 61 is capable of receiving power not only from the main battery 1 via the power supply branch L11 but also from the sub-battery 2 via the sub-power supply path L21. Therefore, in order to avoid the occurrence of inter-battery circulating current in the backup load 61, a diode group 61d is provided. The diode group 61d is constituted by a pair of diodes, similarly to the diode group 60d shown in the first comparative example. Both cathodes of this pair of diodes are disposed facing the backup load 61, and anodes thereof are respectively disposed facing the power supply branch L11 and the sub-power supply path L21.

Diode groups 62d, 63d and so on are similarly provided for the other backup loads 62, 63 and so on. However, providing the diode groups 61d, 62d, 63d and so on for the backup loads 61, 62, 63 and so on in this way invites not only cost increases due to number of components but also cost increases due to the increase in design processes. This problem becomes more prominent with a large number of backup loads as in the second comparative example than in the first comparative example.

Cost increases due to the increase in design processes will be described in more detail. There is a history of designing in-vehicle power supply devices and loads with a design concept that does not employ a sub-battery 2, and diode groups have naturally not been envisaged with the design of these loads. Therefore, in the case of designing the in-vehicle power supply devices 100C and 100D with a design concept that uses the sub-battery 2, the design of the backup loads 60, 61, 62, 63 and so on, in addition to the power supply devices themselves, also needs to be newly carried out taking account of the diode groups.

However, as shown with the above object, as long as an in-vehicle power supply device that is less susceptible to the occurrence of sneak current between a main battery 1 and a sub-battery 2 that supply power externally is obtained, the actual design of the loads targeted for power supply need not be changed, and cost increases due to diode groups being individually provided can also be avoided.

Hereinafter, in-vehicle power supply devices according to a plurality of embodiments will be described. In all of the embodiments, unless particularly stated otherwise, constituent elements to which the same reference signs as the above comparative examples are given perform the same or equivalent functions as the constituent elements of the comparative examples.

### First Embodiment

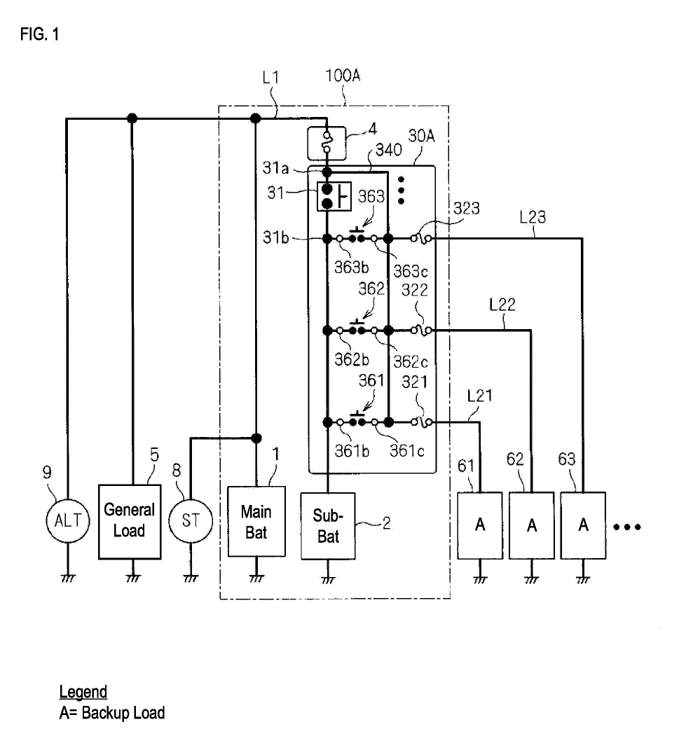

FIG. 1 is a circuit diagram showing the connection relationship of backup loads 61, 62, 63 and so on in addition to a general load 5 with an in-vehicle power supply device 100A that supplies power to these loads.

### Configuration

The in-vehicle power supply device 100A is provided with a main battery 1, a sub-battery 2 and a power supply box 30A. Similarly to the in-vehicle power supply devices 100C and 100D, the in-vehicle power supply device 100A is desirably further provided with a fuse that interposes a power supply box 3 together with the sub-battery 2 and is connected in series to both thereof. Here, the case where this fuse is housed in a fuse box 4, similarly to the first comparative example and the second comparative example, will be illustrated.

The main battery 1 is charged by the power generation function of an alternator 9, from outside the in-vehicle power supply device 100A. A starter 8 is connected together with the general load 5 to the main battery 1, from outside the in-vehicle power supply device 100A. The general load 5 receives power via the main power supply path L1, similarly to the first comparative example and the second comparative example.

The in-vehicle power supply device 100A in the present embodiment has a configuration in which the power supply box 30D of the in-vehicle power supply device 100D in the second comparative example is replaced by the power supply box 30A. The power supply box 30A has the switch 31 described in the first comparative example and the second comparative example. The switch 31 has a pair of ends 31a and 31b. The end 31a is connected to the main battery 1 via the fuse box 4. The end 31b is connected to the sub-battery 2. The main power supply path L1 connects the main battery 1 and the end 31a. From another viewpoint, the switch 31 is interposed between the sub-battery 2 and the fuse that is in the fuse box 4, and is connected in series to both thereof. The sub-battery 2 is connected to the main battery 1 and the main power supply path L1 via the switch 31.

In the present embodiment, the sub-battery 2 respectively supplies power to the backup loads 61, 62, 63 and so on, via sub-power supply paths L21, L22, L23 and so on, similarly to the second comparative example. Also, fuses 321, 322, 323 and so on respectively corresponding to the sub-power supply paths L21, L22, L23 and so on are provided, similarly to the second comparative example. FIG. 1 illustrates the case where the fuses 321, 322, 323 and so on are housed in the power supply box 30A.

The power supply box 30A includes a plurality of contact pairs that are provided for each of the sub-power supply paths L21, L22, L23 and so on, in addition to the switch 31 and the fuses 321, 322, 323 and so on. Specifically, relays 361, 362, 363 and so on are provided as contact pairs. The relay 361 has a first contact 361c and a second contact 361b, the relay 362 has a first contact 362c and a second contact 362b, and the relay 363 has a first contact 363c and a second contact 363b. The second contacts 361b, 362b, 363b and so on are all connected to the end 31b. For example, the relays 361, 362, 363 and so on are the normally-closed relays.

The sub-power supply paths L21, L22, L23 and so on respectively connect the first contacts 361c, 362c, 363c and so on and the backup loads 61, 62, 63 and so on. The first contacts 361c, 362c, 363c and so on are respectively connected to the sub-power supply paths L21, L22, L23 and so on via the fuses 321, 322, 323 and so on. The first contacts 361c, 362c, 363c and so on are also connected to the end 31a by wiring 340. That is, the wiring 340 can be recognized as a connection path that connects the end 31a and the first contacts 361c, 362c, 363c and so on, and supplies power from the main battery 1 to the backup loads 61, 62, 63 and so on.

### Operations

In the case where the charging rate of the sub-battery 2 is low, the switch 31 becomes electrically connected and the sub-battery 2 is charged by at least one of the main battery 1 and the alternator 9. Even if current flows between the main battery 1 and the sub-battery 2 at this time, this current is charging current that flows toward the sub-battery 2 from the main battery 1, and does not adversely affect either battery. In the case where the charging rate of the sub-battery 2 reaches a suitable range, the switch 31 becomes electrically disconnected and charging of the sub-battery 2 is stopped.

The relays 361, 362, 363 and so on are ordinarily set to an electrically disconnected state (open), by a control device which is not shown, such as in-vehicle ECU (engine control unit), for example. Therefore, if the switch 31 becomes electrically disconnected, ordinarily power is supplied from the main battery 1 to the backup loads 61, 62, 63 and so on via the sub-power supply paths L21, L22, L23 and so on through the first contacts 361c, 362c and 363c.

On the other hand, the first contacts 361c, 362c and 363c are not connected to the sub-battery 2, and the sub-battery 2 is cut off from the main battery 1 by the relays 361, 362, 363 and so on and the switch 31. Inter-battery circulating current is thereby avoided, while securing power supply to outside (here, to backup loads 61, 62, 63, etc.).

Note that because the relationship between the switch 31 and the relays 361, 362, 363 and so on is one of being connected in parallel in the present embodiment, whether the relays 361, 362, 363 and so on are in the open state or the closed state does not matter, in the case where the switch 31 is electrically connected. Therefore, in the case where the switch 31 is electrically connected, the above control device may set the relays 361, 362, 363 and so on to the closed state, depending on situations that are not taken into consideration here. In this case, the relays 361, 362, 363 and so on enter the open state, at the same time that the switch 31 becomes electrically disconnected or when a predetermined time period has elapsed thereafter. This predetermined time period can be set to a time period at which inter-battery circulating current is no longer an issue in practical terms, such as when the potential difference between the main battery 1 and the sub-battery 2 is small.

In the case where both the alternator 9 and the main battery 1 lose the power supply function (including failure thereof), the control device sets the relays 361, 362, 363 and so on to an electrically connected state (closed). Alternatively, there are also cases where the control device may be unable to set the relays 361, 362, 363 and so on due to both the alternator 9 and the main battery 1 losing the power supply function. However, if the relays 361, 362, 363 and so on are normally-closed relays, the relays 361, 362, 363 and so on realize the electrically connected state even in such cases.

Power is supplied from the sub-battery 2 to the backup loads 61, 62, 63 and so on via the sub-power supply paths L21, L22, L23 and so on, as a result of the first contacts 361c, 362c, 363c and so on thus respectively connecting to the second contacts 361b, 362b and 363b and so on.

Diode groups 60d, 61d, 62d, 63d and so on such as in the first comparative example and the second comparative example need not be provided for the backup loads 60, 61, 62, 63 and so on, and thus new design processes for the respective diode groups are not required.

The present embodiment is, furthermore, advantageous in that power supply is simplified because power supply branches L11, L12, L13 and so on such as in the second comparative example are not required, and fuses 71, 72, 73 and so on are also not required. Specifically, the number of fuses is reduced by the number of backup loads, as compared with the second comparative example.

The relays 361, 362 and 363 may be provided as individual relays, and the contact pairs may be realized with a plurality of relays.

### Second Embodiment

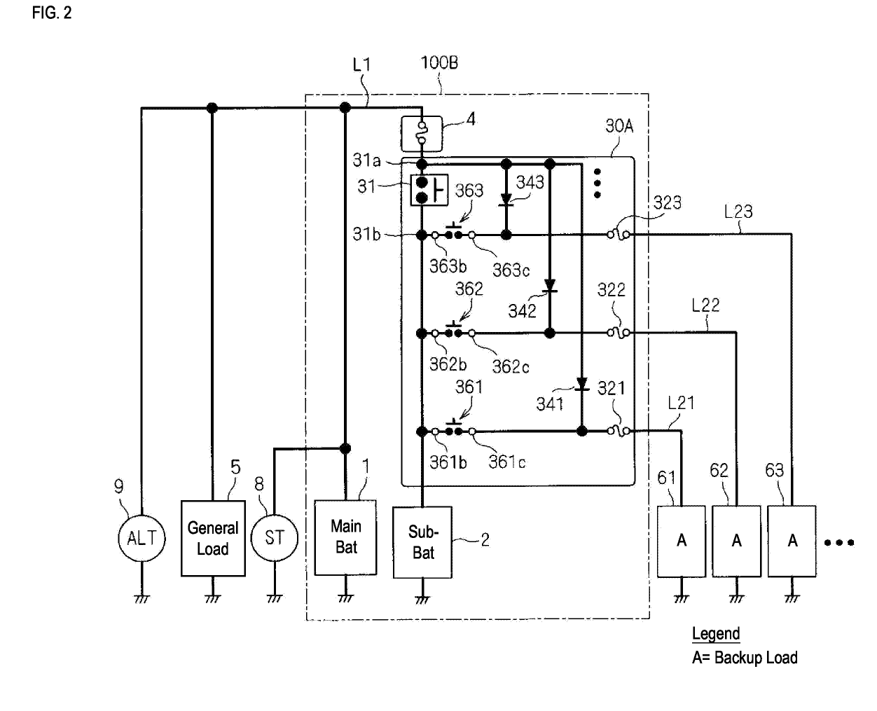

FIG. 2 is a circuit diagram showing the connection relationship of backup loads 61, 62, 63 and so on in addition to a general load 5 with an in-vehicle power supply device 100B that supplies power to these loads.

### Configuration

The in-vehicle power supply device 100B has a configuration in which the power supply box 30A of the in-vehicle power supply devices 100A described in the first embodiment is replaced by a power supply box 30B. The power supply box 30B has a configuration in which diodes 341, 342, 343 and so on are provided instead of the wiring 340.

Anodes of the diodes 341, 342, 343 and so on are connected to an end 31a. Cathodes of the diodes 341, 342, 343 and so on are respectively connected to first contacts 361c, 362c, 363c and so on. Note that the case where the positive electrode of the main battery 1 is connected to the end 31a, and the positive electrode of the sub-battery 2 is connected to an end 31b is illustrated.

The diodes 341, 342, 343 and so on can be recognized as connection paths that respectively supply power from the main battery 1 to the backup loads 61, 62, 63 and so on, similarly to the wiring 340 of the first embodiment. It can be said that the diodes 341, 342, 343 and so on and the pairs of the first contacts 361c, 362c, 363c and so on and the second contacts 361b, 362b and 363b and so on are provided for every connection path. However, in the present embodiment, the connection paths differ from the wiring 340 in preventing power supply to the main power supply path L1 through the first contacts 361c, 362c, 363c and so on.

### Operations

As a result of the relays 361, 362, 363 and so on operating as described in the first embodiment, power is supplied from the sub-battery 2 to the backup loads 61, 62, 63 and so on via the sub-power supply paths L21, L22, L23 and so on, even in the case where both the alternator 9 and the main battery 1 lose the power supply function (including failure thereof). In the operations of the first embodiment, power is also supplied to the general load 5 from the sub-battery 2 via the wiring 340 and the main power supply path L1 at this time. This power supply to the general load 5 causes concern about the possibility of the power supply capability to the backup loads 61, 62, 63 and so on being reduced.

However, in the present embodiment, power supply to the main power supply path L1 through the first contacts 361c, 362c, 363c and so on is prevented by the diodes 341, 342, 343 and so on. Therefore, power supply to the general load 5 from the sub-battery 2 is not carried out, and a reduction in the power supply capability to the backup loads 61, 62, 63 and so on is avoided. That is, according to the present embodiment, a reduction in the power supply capability to the backup loads 61, 62, 63 and so on is avoided, having been similarly successful to the first embodiment.

Of course, in the case where the negative electrode of the main battery 1 is connected to the end 31a and the negative electrode of the sub-battery 2 is connected to the end 31b, the connection direction of the diodes 341, 342, 343 and so on will be reversed. That is, the cathodes of the diodes 341, 342, 343 and so on will be connected to the end 31a, and the anodes thereof will be connected to the first contacts 361c, 362c, 363c and so on.

Although the invention has been described in detail above, the foregoing description is, in all respects, illustrative, and the invention is not limited thereto. It should be understood that innumerable variations that are not illustrated can be conceived without departing from the scope of the invention.

1. An in-vehicle power supply device comprising:
a main battery for in-vehicle use;
a sub-battery for in-vehicle use;
a switch having a first end connected to the main battery, and a second end connected to the sub-battery;
a main power supply path connecting the main battery and the first end;
a relay having a first contact connected to an in-vehicle load, and a second contact connected to the second end, the first contact and the second contact forming a pair; and
a connection path connecting the first end and the first contact, and for supplying power from the main battery to the in-vehicle load.

2. The in-vehicle power supply device according to claim 1,
wherein the connection path is wiring connecting the first end and the first contact.

3. The in-vehicle power supply device according to claim 1,
wherein the connection path includes a diode that prevents power supply to the main power supply path through the first contact.

4. The in-vehicle power supply device according to claim 3,
wherein a plurality of sub-power supply paths connecting the first contact and the in-vehicle load are provided, and
the diode and the pair of the first contact and the second contact are provided for each of the connection paths.

5. The in-vehicle power supply device according to claim 1,
wherein the relay is a normally-closed relay.

6. The in-vehicle power supply device according to claim 2,
wherein the relay is a normally-closed relay.

7. The in-vehicle power supply device according to claim 3,
wherein the relay is a normally-closed relay.

8. The in-vehicle power supply device according to claim 4,
wherein the relay is a normally-closed relay.
